(19) United States
(12) Patent Application Publication
(10) Pub. No.: US 2017/0008086 A1
(43) Pub. Date: Jan. 12, 2017

(54) MANUFACTURE OF COMPONENT WITH COOLING CHANNELS

(71) Applicant: ROLLS-ROYCE plc, London (GB)

(72) Inventor: Simon L JONES, Bristol (GB)

(73) Assignee: ROLLS-ROYCE plc, London (GB)

(21) Appl. No.: 15/197,225

(22) Filed: Jun. 29, 2016

(30) Foreign Application Priority Data
Jul. 6, 2015 (GB) 1511776.5

(51) Int. Cl. B22F 5/00; B28B 1/00; B22F 3/105; B33Y 50/02; B33Y 80/00; F01D 25/12; B33Y 10/00

(52) U.S. Cl. CPC B22F 5/009; F01D 25/12; B28B 1/001; B33Y 10/00; B33Y 50/02; B33Y 80/00; B22F 3/1055; F05D 2220/32; F05D 2230/30; F05D 2250/10; F05D 2300/17; F05D 2300/20

(57) ABSTRACT

A method for the manufacture of a component having an internal cavity is described. The method includes; defining an external geometry of the component, defining a core geometry of the component; using an additive layer manufacturing method, building the component from a plurality of layers laid on a first plane; wherein the core geometry includes a main core passage having a first end wall and a second end wall and is divided by one or more dividing walls, the dividing walls and end walls each having a common profile and wherein the profile includes an incline to the first plane.

### FIELD OF DISCLOSURE

The present disclosure concerns the manufacture of dual wall components which include channels for the passage of cooling fluid. More particularly, the invention relates to a core geometry which facilitates the manufacture of such components using an additive layer manufacturing (ALM) process.

### BACKGROUND TO THE INVENTION

It is known to provide dual wall components using a casting method wherein a core is held in place during the casting process. The dual walls are cast around the core which is subsequently leeched from the cast component leaving a cavity between the walls. The shape of the channels is defined by one or more cores and is limited only by the ability to make a core to the desired shape.

Additive layer manufacturing (ALM) methods are known. In these methods a component is built up layer by layer until the 3D component is defined. In some ALM methods, layers are created by selective treatment of layers within a mass of particulate material, the treatment causing cohesion of selected regions of particulates into a solid mass. For example, the particulate is a ferrous or non-ferrous alloy powder and the treatment involves local heating using a laser or electron beam. Specific examples of such ALM methods include (without limitation); laser sintering, laser melting and electron beam melting (EBM).

Additive layer manufacturing (ALM) techniques are known for use in defining complex geometries to high tolerances and can be used as an alternative to casting. However, such methods are not ideally suited to some conventionally used core geometries.

Cast components which incorporate cooling channels are often used in gas turbine engines to define complex aerodynamic shapes. The casting process and materials used provide materials with very specific mechanical properties which need to be preserved in an environment where they are exposed to extremes of temperature and pressure. As well as serving as cooling channels, hollow cavities provided within these components serve to minimise weight and reduce material costs. The cavities may be connected to external surfaces of the component by a plurality of small cooling holes through which the fluid passes forming a coolant layer which protects the external surfaces.

### SUMMARY OF THE INVENTION

According to a first aspect there is provided a method for the manufacture of a component having an internal cavity, the method comprising;

defining an external geometry of the component,

defining a core geometry of the component;

using an additive layer manufacturing method, building the component from a plurality of layers laid on a first plane;

wherein the core geometry includes a main core passage having a first end wall and a second end wall and divided by one or more dividing walls, the dividing walls and end walls each having a common profile and wherein the profile includes an incline to the first plane.

The method is well suited to ALM methods where each layer must have some support from an underlying layer if the finished component is to have good structural integrity.

By replacing square angled wall intersections as are commonly used in prior art casting geometries with the inclined walls described, it becomes possible to manufacture a core by an ALM method which has good structural integrity. In ALM methods where the layers extend in parallel to the first plane, the lack of support from an underlying layer can result in mechanically inferior properties. It will be appreciated that, for the purposes of cooling, the proportions and cross sectional shapes of the sub passages defined in the main core passage are of importance to ensure optimum flow of coolant through these passages. Accordingly, the dividing walls of the core geometry of the invention are designed with that in mind.

The incline to the first plane is preferred to be at least 30 degrees, more preferably greater than 45 degrees. In some embodiments, the incline is in the range 45 to 60 degrees. The walls may be planar and extend at a consistent incline to the first plane. In another option, the walls may be non-planar, each end inclining to the first plane in a different direction. For example, the walls may meet at a centre line of the core passage to form a chevron shape. It will be appreciated, however, that the walls need not be symmetrical about a centreline and may incline from the first plane at different angles forming a vertex at a position to one side of the centreline. Walls need not be sharply angled and may, for example, have a curved profile.

Optionally the dividing walls have a thickness of from about 0.5 mm to about 2 mm.

The first plane can be orthogonal to a longitudinal axis of the main core passage. The first plane can be parallel to a longitudinal axis of the main core passage. In the latter case, opposing walls in parallel with the longitudinal axis may be profiled.

A component may comprise multiple main core passages which may have the same or different internal geometries. Multiple main core passages may be connected by through wall channels.

For example, the component can be manufactured from a ferrous or non-ferrous alloy or a ceramic. The component may be a component for a gas turbine engine. Additional channels may extend from the main core passage and may serve as cooling channels in the finished component. The additional channels may extend from the main core passage through to external surfaces of the components. In some embodiments, the additional channels may pass though dividing walls. Additional channels may be orthogonal to surfaces at which they enter and exit a wall, alternatively they may be inclined to the orthogonal.

The component may be a dual walled tile, wherein having elongate side walls running in parallel in a direction substantially orthogonal to the build plane P.

It will be appreciated that by changing the shape of core passage dividing walls as described, it becomes possible to manufacture core cavities using DLD or other additive manufacturing processes. Furthermore, by designing the end walls to have a similar profile to the dividing walls, the same area of cooling channels can be preserved. Furthermore, a part can be manufactured without overhanging walls, which in DLD have been found to introduce very rough surface finishes and cracking.

In another aspect, the invention comprises a gas turbine engine incorporating one or more components manufactured in accordance with the method of the invention.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### BRIEF DESCRIPTION OF THE DRAWINGS

Embodiments will now be described by way of example only, with reference to the Figures, in which:

FIG. 1 is a sectional side view of a gas turbine engine which may comprise components made in accordance with the method of the invention;

FIG. 2 is a schematic figure of a component made in accordance with prior known methods;

FIG. 3 shows a first component and the core geometry of the component manufactured in accordance with a method of the invention;

FIG. 4 shows in a second component and the core geometry of the component manufactured in accordance with a method of the invention;

### DETAILED DESCRIPTION OF SOME EMBODIMENTS OF THE INVENTION

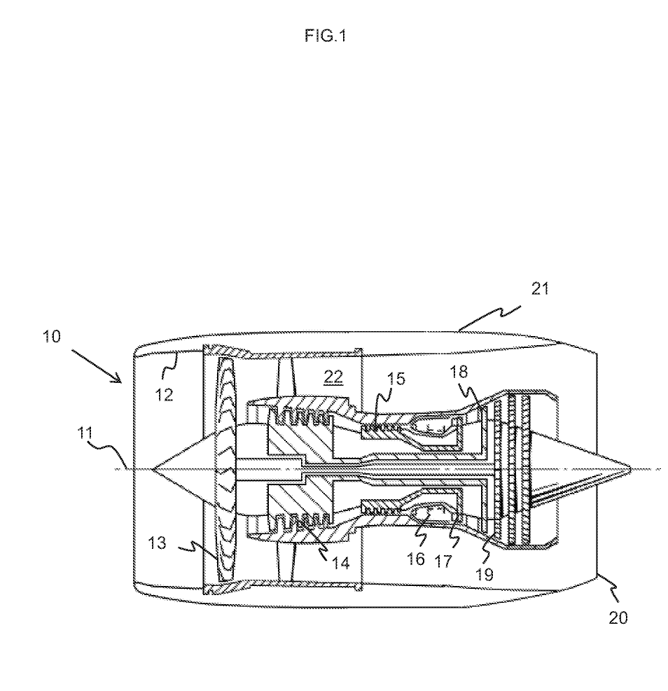

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, and intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

Many components of the gas turbine engine are dual wall components defining internal cooling passages and their internal geometry could be adapted to facilitate their manufacture by the method of the invention. For example (but without limitation), components in the turbine sections 17, 18 and 19, or the combustor 16 may be manufactured in accordance with the invention. The method is well suited to the manufacture of walls and platforms through which cooling air is often distributed to cool components in these sections.

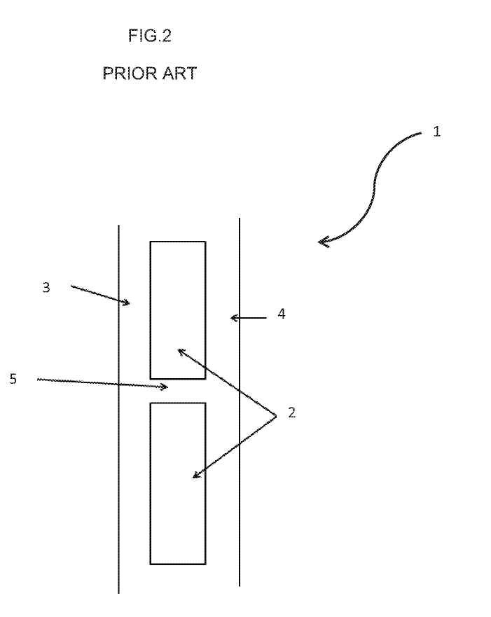

FIG. 2 shows an internal geometry of a prior art component 1 comprising cooling channels 2 and manufactured using a casting method. As can be seen, the cooling channels are bounded by elongate walls 3 and 4 of the component and a dividing wall 5. The walls intersect at right angles and extend in a horizontal plane.

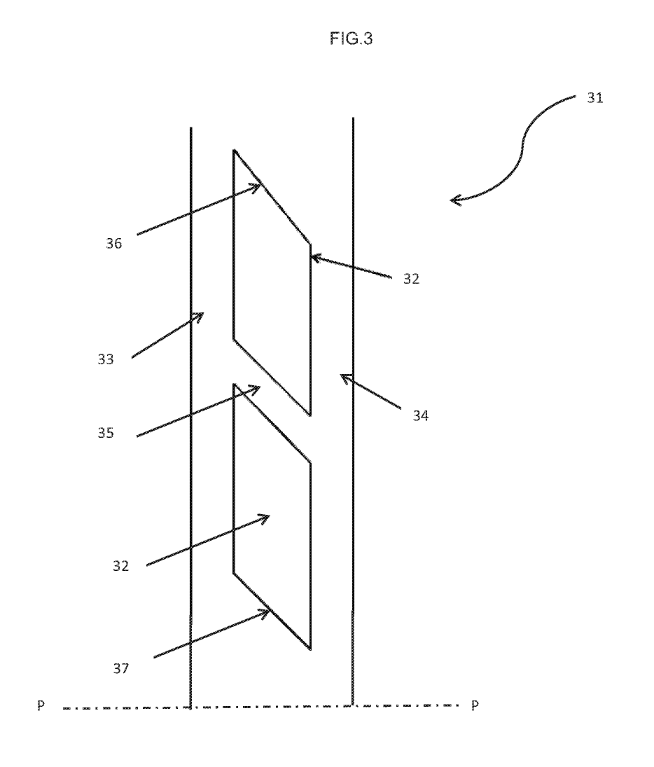

FIG. 3 shows an internal geometry of a component 31 manufactured in accordance with a method of the invention. As can be seen, the component has elongate walls 33 and 34 and end walls 36 and 37 which border a main core passage. The passage is divided by dividing wall 35 to form two cooling channels 32. The component is built in layers upwards from a first plane P, the elongate walls 33, 34 extending orthogonal thereto. End walls and dividing wall 35, 36 and 37 extend between elongate walls 33 and 34 and are inclined to the plane P. As the walls are inclined to the plane and all layers are laid parallel to the plane, each laid layer of the inclined walls 35, 36, 37 provides a support on which to build the next layer.

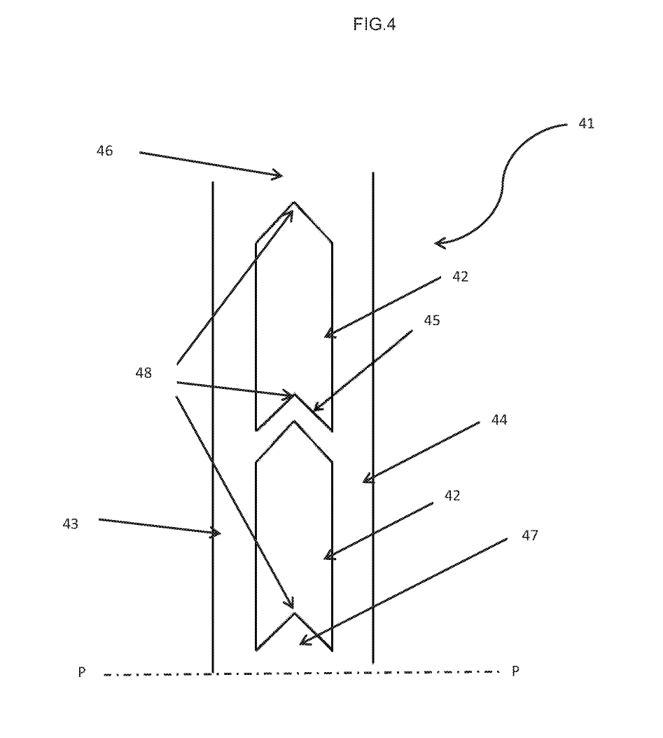

FIG. 4 shows an internal geometry of a component 41 manufactured in accordance with a method of the invention. As can be seen, the component has elongate walls 43 and 44 and end walls 46 and 47 which border a main core passage. The passage is divided by dividing wall 45 to form two cooling channels 42. The component is built in layers upwards from a first plane P, the elongate walls 43, 44 extending orthogonal thereto. End walls and dividing wall 45, 46 and 47 extend between elongate walls 43 and 44. As can be seen opposite ends of the walls 45, 46 and 47 are inclined in opposite directions to plane P and meet at a vertex 48 to form a chevron-like arrangement. As the walls are inclined to the plane and all layers are laid parallel to the plane, each laid layer of the inclined walls 35, 36, 37 provides a support on which to build the next layer.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A method for the manufacture of a component having an internal cavity, the method comprising;
defining an external geometry of the component,
defining a core geometry of the component;
using an additive layer manufacturing method, building the component from a plurality of layers laid on a first plane;
wherein the core geometry includes a main core passage having a first end wall and a second end wall and divided by one or more dividing walls, the dividing walls and end walls each having a common profile and wherein the profile includes an incline to the first plane.

2. A method as claimed in claim 1 wherein the incline to the first plane is at least 30 degrees.

3. A method as claimed in claim 1 wherein the incline is greater than 45 degrees.

4. A method as claimed in claim 1 wherein the incline is in the range 45 to 60 degrees.

5. A method as claimed in claim 1 wherein the walls are planar and extend at a consistent incline to the first plane.

6. A method as claimed in claim 1 wherein the walls are non-planar, opposite ends of the walls inclining to the first plane in a different direction.

7. A method as claimed in claim 6 wherein the walls converge to a vertex at a centre line of the core passage to form a chevron shape.

8. A method as claimed in claim 6 wherein opposite ends of the wall incline to the first plane by a different angle and converge to a vertex which is off a centreline of the core passage.

9. A method as claimed in claim 1 wherein the walls have a thickness in the range 0.5 mm to 2 mm.

10. A method as claimed in claim 1 wherein the first plane is orthogonal to a longitudinal axis of the main core passage.

11. A method as claimed in claim 1 wherein the layers comprise a ferrous or non-ferrous alloy or a ceramic.

12. A method as claimed in claim 1 further comprising additional channels extending from the main core passage through an external wall of the component.

13. A method as claimed in claim 1 further comprising additional channels passing through one or more dividing walls.

14. A component manufactured according to claim 1 and configured for use in a gas turbine engine and wherein the main core passage serves as part of a circuit for distributing coolant to components of the gas turbine engine.

15. A gas turbine engine incorporating one or more components, at least one of the components having the form prescribed in claim 14.
